(19) United States
(12) Patent Application Publication
(10) Pub. No.: US 2015/0356254 A1
(43) Pub. Date: Dec. 10, 2015

(54) Centralized System for Tracking and Maintaining Vascular Access Records Across a Healthcare Continuum

(71) Applicant: Chuck Lee, Franklin, TN (US)

(72) Inventor: Chuck Lee, Franklin, TN (US)

(21) Appl. No.: 14/824,182

(22) Filed: Aug. 12, 2015

Related U.S. Application Data
(63) Continuation of application No. 11/946,655, filed on Nov. 28, 2007.

(51) Int. Cl. G06F 19/00

(52) U.S. Cl. CPC G06F 19/322

(57) ABSTRACT

A system is provided for tracking and maintaining vascular access medical records across a continuum of healthcare facilities, facilitators or providers having respectively compartmentalized vascular access records. The system centrally aggregates vascular access records in association with a patient, with the vascular access records including at least past vascular access services rendered across the healthcare continuum. The system provides access by third party vascular access service providers to the vascular access records, responsive to new vascular access service requests for the patient from any one of the plurality of the healthcare entities. The system further enables supplementing the vascular access records to reflect results from the new vascular access service request, and/or post-service results, wherein the results are available for access in association with subsequent vascular access service requests for the patient by any one of the plurality of healthcare entities.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application is a continuation of U.S. patent application Ser. No. 11/946,655, filed Nov. 28, 2007.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to a system and method for maintaining vascular access medical records. More particularly, this invention relates to a system and method for tracking and maintaining vascular access medical records across a healthcare spectrum (regardless of the requesting facility or the locality of the actual service) and providing those records to practitioners who can utilize them.

It is not an atypical occurrence to go to a doctor's office or hospital and receive saline or other liquid/medication intravenously (IV), commonly placed in the top of the hand or along the length of the arm. The IV may be necessary to re-hydrate a dehydrated patient, to administer antibiotics to treat an infection or anesthesia prior to a surgery, as part of a diagnostic procedure, or for any other of a multitude of reasons. Receiving an IV, as described above, is merely one type of vascular access procedure. Other types of vascular access procedures involve inserting a catheter (a long, thin tube) into a vein near the collarbone and then threading the catheter into a major vein in the chest. This type of vascular access procedure is often needed for long-term access as would be required for chemotherapy, long-term feeding, or extended antibiotic treatments. However, generally speaking, vascular access refers to the process of gaining intravenous access to a patient.

It is also not unusual for a doctor or nurse to have difficulty placing an IV or performing another type of vascular access procedure. This may be the result of factors ranging from the patient's anatomy, i.e. vein location or size, to the type of procedure or equipment used. Whatever the cause, repeated attempts to secure vascular access often result in pain and discomfort for the patient and increased costs—whether from the additional time spent by the practitioner on the subsequent attempts, the supplies consumed during those attempts, or complications arising from the procedure.

For exemplary purposes consider a patient, at a hospital, requiring vascular access. Further consider that several unsuccessful attempts are made; the unsuccessful attempts can be directly attributed to the patient's unique vascular anatomy. After several more attempts the hospital employee appreciates the patient's unique anatomy and successfully applies a new technique to gain access. Some time later, the same patient is at his/her doctor's office and it is determined that the patient needs intravenous antibiotics to treat an infection. Without the practitioner having knowledge of the vascular access attempts made at the hospital, it is likely the patient's experience at the doctor's office will mirror that had at the hospital; namely, several unsuccessful attempts before access is gained.

If the practitioner would have had the hospital's vascular access records, and the knowledge gleaned therefrom, it is likely the practitioner could have expedited the vascular access process as the practitioner could have commenced with the known effective technique(s). However, even if circumstances prohibit the practitioner from using the procedure successfully employed at the hospital, the practitioner would still have the benefit of the knowledge gained from the hospital's unsuccessful attempts. This knowledge may prove invaluable in formulating the practitioner's course of action.

Unfortunately, the present healthcare system does not promote the sharing and dissemination of vascular access records. Currently in the healthcare system, the methodology of recording data fails to capture vital patient-specific vascular access information. What little information is obtained by traditional means remains very compartmentalized within each healthcare provider system. As discussed above, it is not the aberrant situation when one patient is treated at a multitude of healthcare facilities and requires vascular access at one or more of those facilities. Moreover, it would not be anomalous for a healthcare provider treating a patient to be ignorant of that patient's vascular access treatment while under the care of another provider. Although this scenario may not present obstacles for some types of treatments, vascular access is not one of them.

A substantial amount of time, effort, and discomfort could be avoided if vascular access information for patients, previously treated, was readily accessible to subsequently treating practitioners. With this information the practitioners could bypass procedures or techniques that are known to be ineffective for a particular patient. This is especially the case when the patient is venous depleted or otherwise presents vascular challenges.

One of the myriad of problems that may occur as a result of vascular access complications, i.e. repeated unsuccessful attempts, is catheter related blood stream infections (CR-BSI). The average cost associated with treating a CR-BSI is over $82,000 per instance. It is further estimated that the economic burden, in 2005, for treating CR-BSI's was nearly $4.5 billion nationwide. Obviously, it is imperative to take steps to minimize the occurrence of CR-BSI's and other vascular access related complications; from both economic and, more importantly, patient well-being standpoints. It is precisely these types of worriment at which the present invention is aimed.

It is crucial that any healthcare system have a reliable and robust system and/or method for tracking and maintaining vascular access medical records. However, this can be very problematic when dealing with patients who receive healthcare across a continuum of healthcare providers. Medical records are typically corded to the facilities at which the patients are serviced. This rigid relationship is evinced when one considers that if a patient has an appendectomy at Hospital A there is no guarantee, or even a likelihood, that Hospital B will be independently aware of the surgery. In many situations this is of no great import. It is unlikely that knowledge of the patient's appendectomy will alter the way Hospital B treats the same patient for a broken finger three years later. However, the same cannot be said of many vascular access procedures.

A patient with a unique veinal structure may greatly benefit if the practitioner has access to his/her past vascular access records. For example, assume a patient was previously subjected to a toilsome vascular procedure while under Provider B's care. During this process it was learned that the patient was not responsive to a specific technique. It would be significantly advantageous to the patient, and the practitioner, if such information was known to other providers before attempting any future vascular access procedures.

Vascular access is a procedure that may be performed on a single patient many times over the patient's life. As previously noted, vascular access is needed in a plethora of procedures; such as administering pharmaceutics, nutrients, anesthesia, or drawing blood. Because of the frequency in which vascular access is needed, and the diversity of institutions at which it is performed, the benefit of having access to previous vascular records is manifest. Many other types of medical procedures may happen only once during a patient's life, i.e. appendectomy, and because of this singular nature access to past records recounting these procedures is of limited use. But the same cannot be said of vascular access records. Thus, the need to track and share vascular access records differs in kind from that of general medical records.

Consequently, what is needed are a system and method for tracking and maintaining vascular access medical records that will allow vascular access practitioners, among others, to assimilate the knowledge gained from previous vascular access procedures employed on a particular patient so that any future vascular access service will avoid the mistakes of the past. This can only be accomplished by engendering the practitioners with the ability to access vascular records generated from vascular services regardless of where those services occurred. Methods and systems for maintaining medical records are not fields that have been ignored in the prior art. Rather, the prior art is replete with examples of such endeavors.

For example, U.S. Pat. No. 5,974,389 issued on Oct. 26, 1999 to Melanie Ann Clark et al discloses a medical record system having a plurality of computer terminals wherein each terminal has access to a central database having patient records. The computer terminals are responsive to a set of access rules so that the rules control when and which portions of patient record(s) may be accessed by any one of the terminals at a given instance. Accordingly, each terminal may access and manipulate, at least of portion of, the patient record but only under the constraints of the rules.

U.S. Pat. No. 5,772,585 issued on Jun. 30, 1998 to Marianne Lavin et al discloses a method of managing and manipulating medical records. Namely, the patent discloses a method of allowing healthcare workers access to a central database comprised of medical, demographic, insurance, and/or accounting information so that as the patient is processed through the facility, the different healthcare workers and administrators may access the central database and update it as needed.

From the preceding discussion, it is clear that the prior art has made strides towards creating a platform from which multiple healthcare practitioners may access and update patient records. However, the prior art is devoid of any methods or systems that allow one to track, record, and maintain the vascular access treatment of one patient across a continuum of distinct healthcare providers—a covetable end. The present invention seeks to rectify such deficiencies by providing a system and method by which vascular access services, independent of the facility at which they were rendered, are tracked and recorded. The present invention makes the records available to practitioners performing subsequent vascular access services, on previously treated patients, so that the information contained in the records can be utilized to better care for the patients.

### BRIEF SUMMARY OF THE INVENTION

The present invention involves receiving a vascular access service request from a healthcare entity. After the request has been received, a database containing patient records is searched for the patient to whom the new vascular access service request is directed. The patient records are populated with past vascular access service requests, if any, for that particular patient. The past requests may have emanated from a number of distinct healthcare entities. Thus, the database houses all of the requests for vascular access service for a patient regardless of the origin of the request.

The next step depends on whether a patient record, corresponding to the patient identified in the new service request, exists in the database. If no record exists, a new patient record will be generated and populated with the information from the new vascular access service request. If a patient record is found, then the patient record will be updated to reflect the new service request.

Next, the new service request is disseminated, preferably across an electronic communication network, to a vascular access practitioner. Having received the new service request, the vascular access practitioner is now able to review the patient's record and discern if any past vascular access service request have been performed. If past service requests have been performed, then the vascular access practitioner is able to base his or her course of action off of the past procedures attempted and, more importantly, the success of those procedures. This permits the vascular access practitioner to ameliorate the vascular access process and provide expedited service to the patient. Additionally, this process curtails the unnecessary expenses associated with attempting procedures that are known to be ineffective for a particular patient.

After the vascular access practitioner has completed the new service request, the practitioner may then access the patient record and supplement it to include the results from the new service request. These results include the procedures used, the success of the procedures, any supplies consumed during completion of the process, and any pharmaceutics administered. The entry may also include other pertinent information such as, but not limited to, other persons involved in the process from the requesting healthcare entity or comments concerning follow-up service. Thus, one aspect of the present invention is a method for maintaining vascular access medical records, accumulated independent of the requesting healthcare entity, having a past vascular access history, if any, that can be utilized to more effectively treat patients requiring future vascular access.

Additionally, the present invention is a system for tracking and maintaining vascular access medical records. The system includes a data storage device connected to a communication network allowing the data storage device, and components therein, to be accessed across the communication network. A database is associated with the data storage device. The system also includes a patient record which is housed in the database and contains information about a particular vascular access patient.

Furthermore, the patient record includes a vascular access service request field that contains information about a new vascular access service request. This request may come from any number of healthcare providers and typically includes, but is not limited to, information such as patient name, location, type of service needed, and service schedule. Also contained in the patient record is a past service record which chronicles the past vascular access history of the patient regardless of where, or from whom, the request emanated.

To record post-service information, the patient record includes a vascular access service entry. The entry may contain such information as the practitioner's notes concerning the procedures employed, the success of those procedures, supplies consumed, pharmaceutics administered, and follow-up care notes.

The system also includes a network client connected to the communications network. The client allows a practitioner or other healthcare provider to access the patient record and amend it, specifically the service field, to reflect the receipt and/or completion of a new vascular access service request.

Accordingly it is an object of the present invention to provide a system and method for maintaining vascular access records.

It is another object to aggregate vascular access service histories, regardless of who requested the services or where the services occurred, into one comprehensive file.

It is yet another objective of the present invention to provide the comprehensive past services file to vascular access practitioners so that the practitioners may learn from the prior services.

### BRIEF DESCRIPTION OF THE SEVERAL VIEWS OF THE DRAWINGS

FIG. 1 is a block diagram of the relationship between the patient profile, the memory and the network server.

FIG. 2 is a block diagram representing the structure of the vascular access medical record database and the records contained therein.

FIG. 3 is a flow chart showing one embodiment of a method for maintaining vascular access medical records.

FIG. 4 shows an exemplary group of entries contained in the vascular access service file.

FIG. 5 shows one preferred embodiment of the communication network relating the network client, the server, and the remote network device.

FIG. 6 is a flow diagram showing another embodiment of a method for maintaining vascular access medical records.

FIG. 7 is a flow diagram showing yet another embodiment of a method for maintaining vascular access medical records.

FIG. 8 is a block diagram representing the structure of the data storage device and the information contained therein.

FIG. 9 shows one preferred embodiment of a new vascular access service request.

FIG. 10 shows one embodiment of patient information organized in the database.

FIG. 11 shows one embodiment of a patient record.

### DETAILED DESCRIPTION OF THE INVENTION

The present invention relates generally to a system and method for maintaining vascular access medical records. More specifically, the present invention relates to a system and method for maintaining vascular access service records for patients having received vascular access services from, or directed by, more than one healthcare provider. These services may have been requested by, or received at, hospitals, skilled nursing facilities, long-term acute care facilities, home health and hospice agencies, infusion pharmacies, prison systems, physicians' offices, or ambulatory infusion clinics. However, this is far from an exhaustive list and is not a limitation of the present invention.

The system and methods described in the present invention may be utilized by any person or organization facilitating or otherwise involved in vascular access services. This includes both institutional healthcare providers, those responsible for the overall care of a patient, and third-party service providers, those focused only on specific aspects of patient care, i.e. an independent provider of vascular access related services.

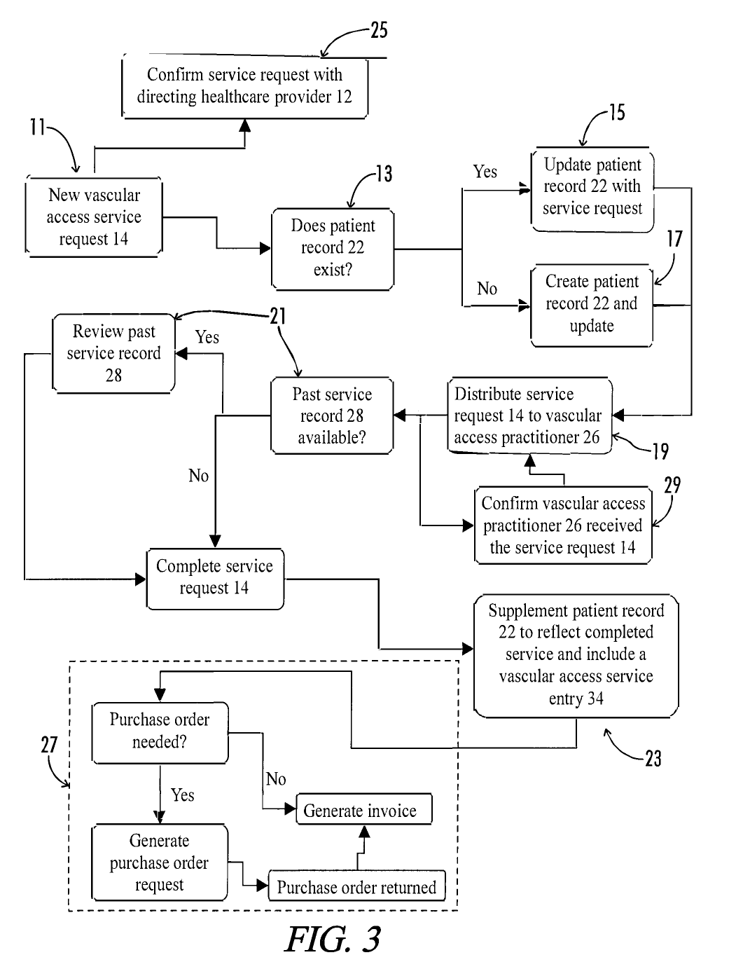

FIG. 3 shows a flow chart of one embodiment of the present invention. As shown at 11, initially a new vascular access service request 14 is received from one of the aforementioned healthcare providers 12 (also referred to as a directing healthcare provider 12). The service request 14 may be received in a myriad of ways; such as through a web submission, an email message, a SMS message, a telephone call, a mail request, or any other type of correspondence. In one preferred embodiment, the service request 14 will be received by a dispatch nurse employed by a third-party service provider. However, the present invention also envisions after-hours requests that may be initially received by an answering service that, in turn, contacts the dispatch nurse and communicates the request. The dispatch nurse may be made aware of the request in ways similar to that of the initial request 14 by the provider 12.

After the dispatch nurse has been made aware of the vascular access service request 14, the dispatch nurse may use a network client 18 to search a database 20 for a patient record 22 associated with the patient. This step is depicted in FIG. 3 at 13. In one preferred embodiment, the network client 18 is a personal computer that is connected to a communication network 24 wherein the database 20 resides in a network server 48 also connected to the communication network 24. However, it is within the scope of the present invention that the database 20 is stored in a local client machine.

If the patient record 22 is not found in the database 20, then the patient record 22 will be generated and stored in the database 20, as shown at step 17. Further, the patient record 22 will be populated to reflect the new service request 14. However, as depicted at step15 in FIG. 3, if the patient record 22 is found in the database 20, then the patient record 22 will simply be updated to reflect the submission of the new service request 14. One way to determine if a patient record 22 already exists in the database 20 is to search by the patient's social security number to determine if a duplicate already resides in the database 20. The present invention also envisions searching for the patient in the database 20 by first or last name, requesting healthcare provider 12, type of procedure, date of procedure, or any other discriminating factor that may aid in the search process.

Once the patient record 22 has been updated to include the new request 14, the dispatch nurse will communicate the request 14 to a vascular access practitioner 26 as shown in step 19 on FIG. 3. Preferably, this is communicated to the practitioner 26 through the communication network 24. This communication could be embodied in an email, an SMS, another type of electronic communication, or simply by way of a telephone call. Preferably, the practitioner 26 may be an IV nurse specialist or someone with similar training capable of handling the vascular access service request 14. If the practitioner 26 is unavailable, cannot be reached, or will be delayed in responding to the request 14, the dispatch nurse may notify the requesting healthcare provider 12 so that alternative arrangements can be made. Furthermore, it is in the province of the present invention that the communication to the practitioner 26 of the service request 14 may be accomplished by having the practitioner 26 log on to the communication network 24 and access an assignment list containing the service request 14. The practitioner 26 may then annotate the assignment list accordingly, to convey that he/she has either accepted or declined the assignment.

Preferably, the patient record 22 includes a past service record 28 containing the past vascular access service requests 30. These past vascular access service requests 30 represent previous requests associated with the patient made by any healthcare provider, not only the directing healthcare provider 12 which has requested the current service 14. FIG. 2 illustrates the relationship and the potential content of the database 20: the patient record 22, the past vascular access service request 30, the new vascular access service request 14, a vascular access service entry 34, and a past service record 28.

Step 21 on FIG. 3 illustrates the ability of the practitioner 26 to access the patient record 22 and obtain information, if any, concerning past vascular access service requests 30 contained in the past service record 28. The availability of the past vascular access service record 28 engenders the practitioner 26 with the knowledge gained from previous service requests associated with the patient. This would include vascular access procedures utilized and the success of the procedures. Also, the patient record 22 may include other notes, such as patient disposition or tolerance to certain procedures that may aid practitioners with future procedures. The information provided in, and the knowledge gleaned from, the patient record 22 will permit the new service request 14 to be fulfilled without duplicating any prior unsuccessful procedures used in completing previous vascular access service requests. If no past vascular access service requests 30 are available, then the vascular access practitioner 26 will implement and complete the new vascular access service request 14 according to his/her experience and specialized training.

Preferably, the practitioner 26 would be able to access the patient record 22, and the included past service record 28, through the communication network 24. Even more preferably the practitioner 26 would be able to access this information across the network 24 utilizing a remote network device 42. Ideally, the remote network device would be a wireless device such as a palm pilot, a trio, or any other type of personal digital assistant or portable electronic device.

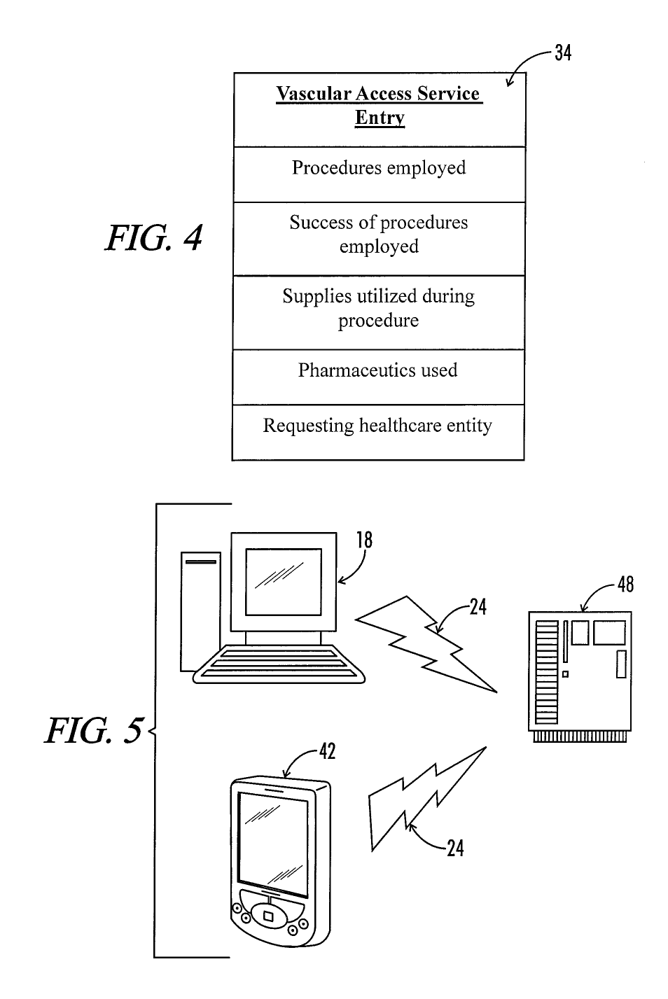

Once the new vascular access service request 14 has been completed, the practitioner 26 may access the database 20 and supplement the patient record 22 to reflect the completion of the service request 14. Step 23 shows this may be accomplished by adding, or merely amending if already existing, a vascular access service entry 34. As shown in FIG. 4, a vascular access service entry 34 may include the procedures employed in the course of completing the new vascular access service request 14, the success of said procedures, any supplies utilized during any of the procedures attempted, any pharmaceutics used during the course of completing the request 14, the requesting healthcare provider 12, or any other pertinent information that may be beneficial to providing vascular access service for this patient in the future, or in generating accounting or inventory information.

It should also be considered that the vascular access service actually performed by the practitioner 26 may deviate from the service request 14 as dictated by clinical circumstances and conditions. Examples of typical types of services performed are extended dwell peripheral catheters, also known as peripherally inserted central catheters, a dressing change, a phone consultation, ocular resolution, catheter repair, blood draw, port access, or simply education.

As previously mentioned, in one preferred embodiment, an important aspect of the present invention is the ability to receive, assimilate, and then utilize knowledge gained from past vascular access service requests 30 in the performance of the new service request 14. To this end, it is beneficial to receive a second vascular access service request from a healthcare provider; preferably, a second directing healthcare provider, for the same patient for whom the new service request 14 is directed—the new service request 14 anti-dating the second service request.

Thus, in one preferred embodiment, both after the request 14 and second request have been completed, the patient record 22 will be updated to reflect the completion and outcome of the two service requests. Consequently, it is readily apparent that after N number of vascular access service requests, the database 20 and specifically the patient records 22 will be replete with past vascular access service requests 30 that provide substantial and meaningful information to practitioners 26 as they are called to perform new service requests on patients having patient records 22. The valuable information provided in the patient records 22 will enable the practitioners 26 to expeditiously affect the new vascular access service requests 14.

Once again, referring to FIG. 3, at step 25 the receipt of a new vascular access service request 14 with the directing healthcare provider 12 is confirmed. This can be accomplished through a telephone call, any type of electronic communication, or personal correspondence. Preferably, it will be the dispatch nurse conducting this communication and in so doing, the dispatch nurse will advise the provider 12 of the practitioner's expected time of arrival so that the provider 12 may prepare accordingly.

One preferred embodiment of the present invention envisions generating a purchase order 40 for the new vascular access service request 12 and then transmitting the purchase order 40 to the directing healthcare provider 12 after the service request 14 has been completed. This is shown at step 27 in FIG. 3. The generation of the purchase order 40 may be created when the practitioner 26 supplements the patient record 22 to reflect the completion of the service request 14.

Preferably, a message will be generated to the dispatch nurse detailing that the service request 14 has been completed thereby prompting the dispatch nurse, or a member of the office staff, to generate a purchase order 40 if the practitioner has not. Even more preferably, the message and/or purchase order may be automatically generated when the completion of the service request 14 has been entered (whether by the practitioner 26 or other personnel). The purchase order request maybe transmitted to the healthcare provider 12 by standard mail, hand delivery, fax, email, or any other type of electronic communication. Depending on the directing healthcare provider 12 and the accounting arrangements therewith, a purchase order 40 may not be necessary. If no purchase order 40 is necessary, then an invoice can be generated and sent to the healthcare provider 12. However, if a purchase order 40 is necessary, then one can be produced through the process described above.

To ensure robustness in the present invention, one preferred embodiment suggests confirming that the new service request 14 has been received by the practitioner 26 as shown at step 29 on FIG. 3. Preferably, the practitioner 26 may have a wireless network device 42 connected to the communication network 24 through which the practitioner 26 may confirm the receipt of the service request 14 with the dispatch nurse. FIG. 5 depicts the network client 18 and its connectivity to the network server 48 and the network device 42. However, FIG. 5 merely describes one preferred embodiment and it will be obvious to one of ordinary skill in the art that a plethora of implementations may serve to satisfy the same end.

This confirmation process also allows the practitioner 26 to inform the dispatch nurse of any problems in satisfying the service request 14 that may cause a delay in the completion of the request 14. Such delay being reportable to the provider 12 so alternative arrangements may be made. Moreover, the confirmation provides the practitioner 26 with the opportunity to question the dispatch nurse or inform the dispatch nurse of any concerns the practitioner 26 may have in carrying out the service request 14.

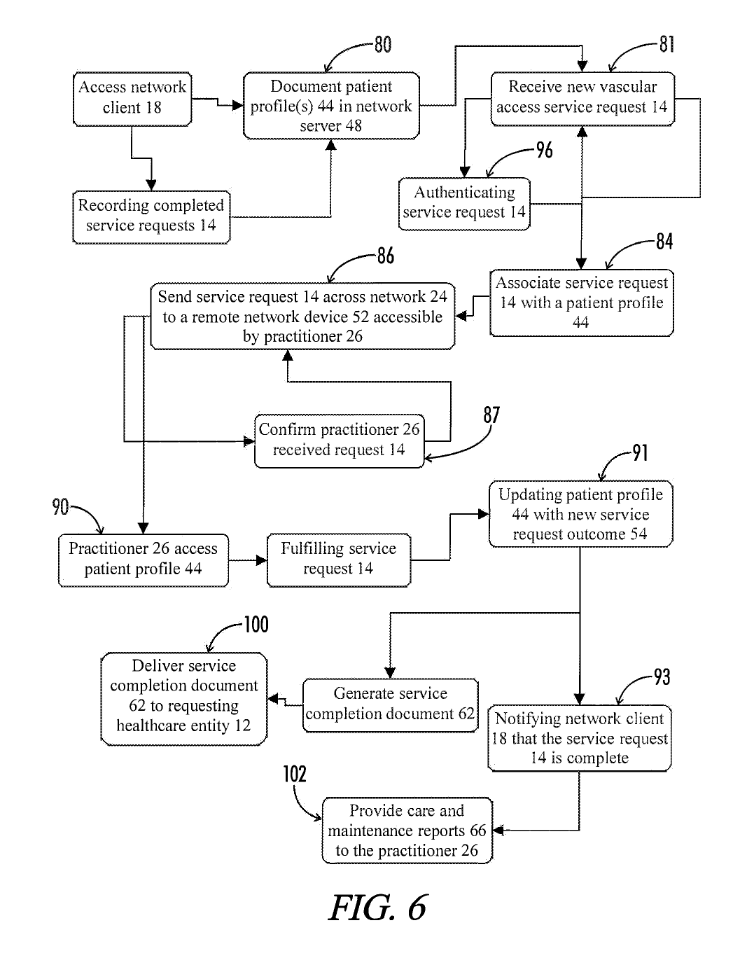

In another preferred embodiment, the method for maintaining vascular access related medical records may be achieved by the steps shown in FIG. 6. Initially, a network client 18 is used to document a patient profile 44 in a memory 46 in a network server 48 through a communication network 24 as shown at step 80. Preferably, the network client 18 will be a personal computer and the communication network 24 will utilize a LAN or WAN. However, an http-based infrastructure or mixed infrastructure is within the scope of the invention.

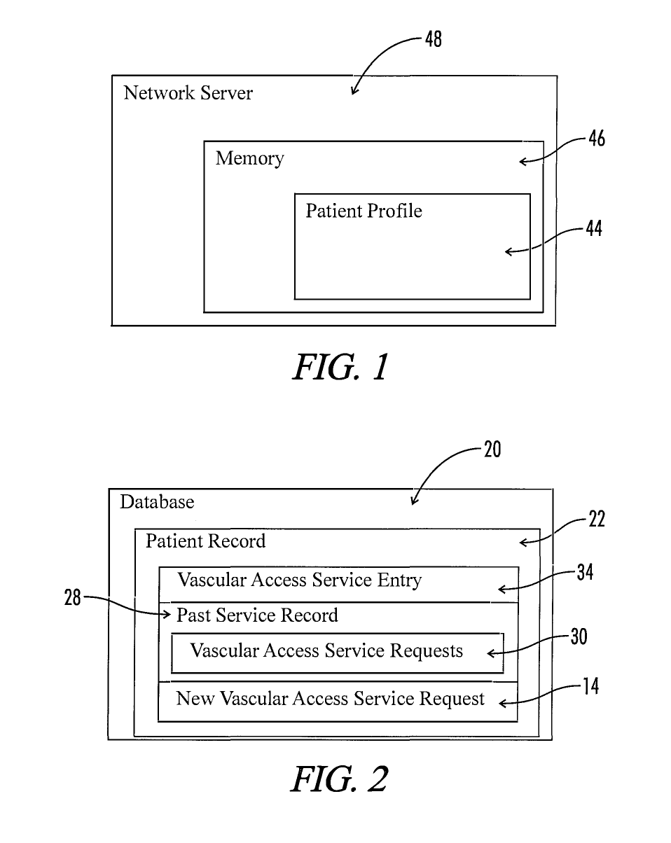

The patient profile 44 includes a past vascular access service field 50 (not shown) containing past vascular access service requests 30 for the patient from healthcare facilitators. The term “healthcare facilitators” encompasses any entity that has, in the past, requested a vascular access service. Thus, the patient profile 44, and particularly the past vascular access services field 50, are an amalgamation of past vascular access service requests 30 from all healthcare facilitators that have requested service for the patient in the past. FIG. 1 depicts the relationship between the network server 48, the memory 46, and the patient profile 44.

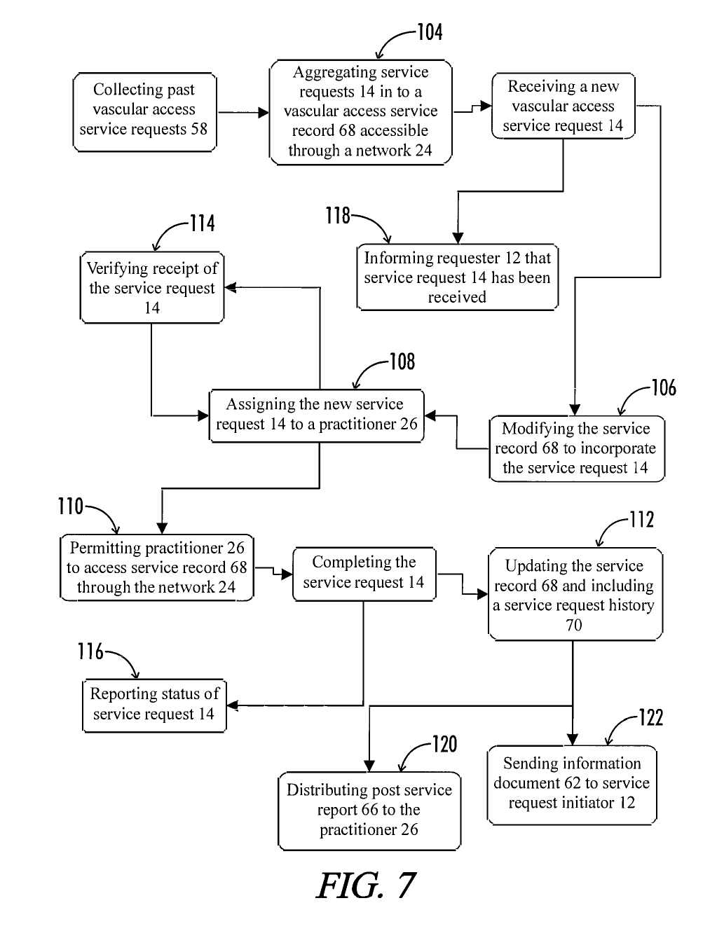

FIG. 7 shows an alternative embodiment, similar to that shown in FIG. 6, that has a vascular access service record 68 composed of a plurality of past vascular access service requests 58, the service record 68 being stored in the database 20 of a network server 48 that is connected to a communication network 24. The past service requests 58 can be for any patient from any requesting healthcare provider. Thus, step 104 provides a comprehensive collection from which patient-related information can easily be mined and distributed.

Now referring to FIG. 6, steps 82 and 84 represent the receipt of a new vascular access service request 14 from a healthcare entity 12 or provider 12. Subsequently, the request 14 is associated with the patient profile 44 using the network client 18. FIG. 5 shows one preferred embodiment of the communication between the network client 18 and the network server 48 over the communication network 24. This communication may occur through a wired or wireless transmission medium. As ensuing vascular access service requests are received, they too will be appended to the patient profile 44 to create one comprehensive information bank. Step 106 in FIG. 7 illustrates updating the service record 68 to incorporate the service request 14. Preferably, this is accomplished by using the network client 18 to access the database 20 over the communication network 24.

Once the vascular access service request 14 has been received, it is ushered, or assigned, through the communication network 24, preferably at the command of the network client 18, to a remote network device 52 accessible by the practitioner 26 as shown by step 86 in FIG. 6 and step 108 in FIG. 7. Desirably, the network device 42 is a wireless device. This configuration permits the healthcare practitioner 26 to receive the request 14 without the need to have access to a traditional terminal such as a desktop PC. The mobility afforded by the remote network device 42 readily accommodates the itinerate nature of the healthcare practitioner's duties and assignments.

To ensure a robust and resilient system, the healthcare practitioner 26 will confirm the receipt of the new vascular access service request 14; preferably through the remote network device 42. This is shown at step 88 on FIG. 6 and step 114 in FIG. 7. This will allow the dispatch nurse, desirably receiving the confirmation through the network client 18, to have confidence that the vascular access service request 14 will be performed.

Step 90 in FIG. 6 and step 110 in FIG. 7 illustrate the ability of the practitioner 26 to access the patient profile 44, service record 68, or database 20 and thereby the past vascular access service requests 58 after receiving the service request 14. Preferably, the practitioner 26 both receives the request 14 and accesses the profile 44 or record 68 through the network device 42. This process permits the practitioner 26 to review the procedures, or techniques, utilized in the past for the patient in question. This aids the practitioner 26 in determining what course of action should be employed for the current service request 14. Having access to this patient profile 44 and/or record 68 allows the practitioner 26 to circumvent the traditional trial and error process that would be required in the absence of access to the information contained in the patient profile 44.

After the service request has been fulfilled, the practitioner 26 will update the patient profile 44, or record 68, to include a new service request outcome as shown at step 92 in FIG. 6, or a service request history 70 shown in step 112 in FIG. 7, respectively. The new service request outcome and history 70 have many of the same elements as that described for the vascular access service entry 34; namely, the procedures employed, the success of the procedures employed, supplies utilized during the procedure, pharmaceutics utilized, the requesting healthcare entity, and any other information deemed pertinent by the practitioner 26.

Additionally, the practitioner 26 may send a notification to the network client 18 through the communication network 24 informing the dispatch nurse, or other appropriate personnel, that the new vascular access service request 14 has been completed. This is depicted in step 94 in FIG. 6 and step 116 in FIG. 7.

Similarly, as to that described in one of the previous preferred embodiments, step 96 in FIG. 6 and step 118 in FIG. 7 represent the process of authenticating the service request 14 with the healthcare entity 12 to confirm the details of the service request 12. This merely informs the requesting entity 12 or provider 12 that the service request 14 will be processed and clarifies any ambiguities. It is also envisioned by the present invention that either during the initial receipt of the service request 14 or during the step shown at 96, the dispatch nurse or vascular healthcare practitioners 26 may participate in a phone consultation with the requesting healthcare entity 12. This may involve assisting the requesting healthcare entity 12 with determining what action, if any, is necessary for the patient. These phone consultations may also be recorded in the patient profile 44 or record 68.

Subsequent to the fulfillment of the service request 14, a service completion document 62 or information document 62 may be generated and delivered to the healthcare entity 12, as shown in step 100 in FIG. 6 and step 122 in FIG. 7. Although not limited to the following, it is envisioned that the service completion document or information document 62 will contain a summary of the procedures used to fulfill the service request 14, any supplies used, the overall outcome of the service request 14, and/or accounting and billing information. The service completion document 62 may be delivered to the healthcare entity 12 through an electronic means such as email, fax, SMS, or through traditional mail. Furthermore, the service completion document 62 may be delivered to the healthcare entity 12 prior to the practitioner 26 vacating the premises following the close of the practitioner's work at the healthcare entity's facility.

However, such a comprehensive document as the service completion document 62 might provide information in excess of that which is desired to convey to the provider 12. In such circumstances, an abridged service completion document may be given to the provider 12 containing only customer specific information.

As shown in step 102 in FIG. 6 and step 120 in FIG. 7, it is disclosed to provide care and maintenance reports or post-service reports 66 to the healthcare practitioner 26 so that the healthcare practitioner 26 may receive notices, i.e. post-services data, concerning follow-up care incident to the service request 14. The care and maintenance reports 66 will include information such as, but not limited to, dressing change schedule, troubleshooting efforts, discontinuation of the vascular access service (and at who's direction), or any other relevant information that the practitioner 26 will need to know when providing care subsequent to the initial vascular access service request 14.

Preferably, the care and maintenance reports 66 will be grouped so that all of the patients at the same healthcare entity 12 will be contained in one care and maintenance report 66 or at least viewable through a patient record aggregation process. This allows the healthcare practitioner 26 to easily access all of the patients requiring care or attention at the same facility—allowing optimum treatment efficiency. Additionally, as the healthcare practitioner 26 performs items listed on the care and maintenance reports 66, the practitioner 26 will update the patient profile 44 or record 68 accordingly. As is the tenet of the present invention, this allows all the relevant information to be contained in one database, and more specifically one record, the patient record 44. Furthermore, the practitioner 26 may transmit to the requesting healthcare entity 12 the items performed on the care and maintenance reports 66.

The information collected in the patient profiles 44 and the care and maintenance reports 66 may be used to generate daily, weekly, monthly, quarterly, and year-to-date volume reports that may display running totals with respect to inventory consumed, services rendered, customer account information, practitioner efficiency or effectiveness, complications resultant from the services rendered or pharmaceutics administered, and/or projections for future service and inventory demand.

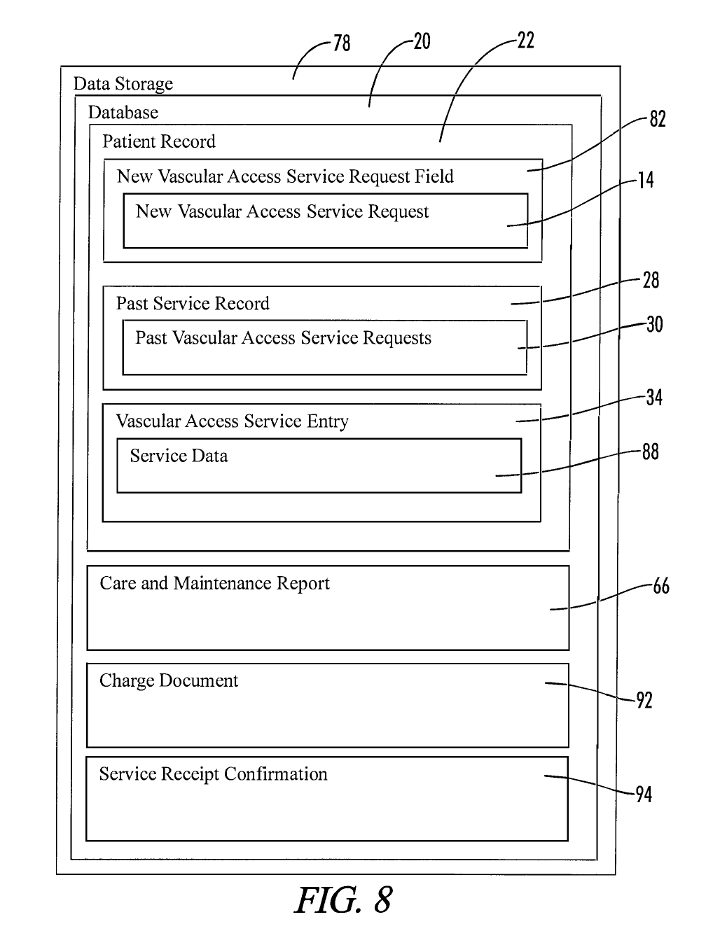

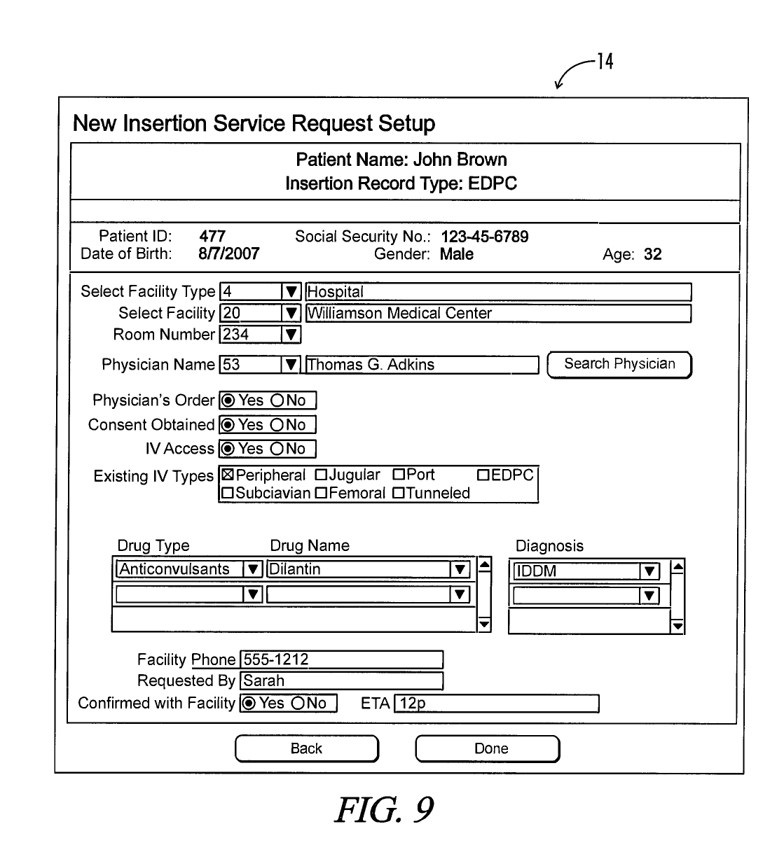

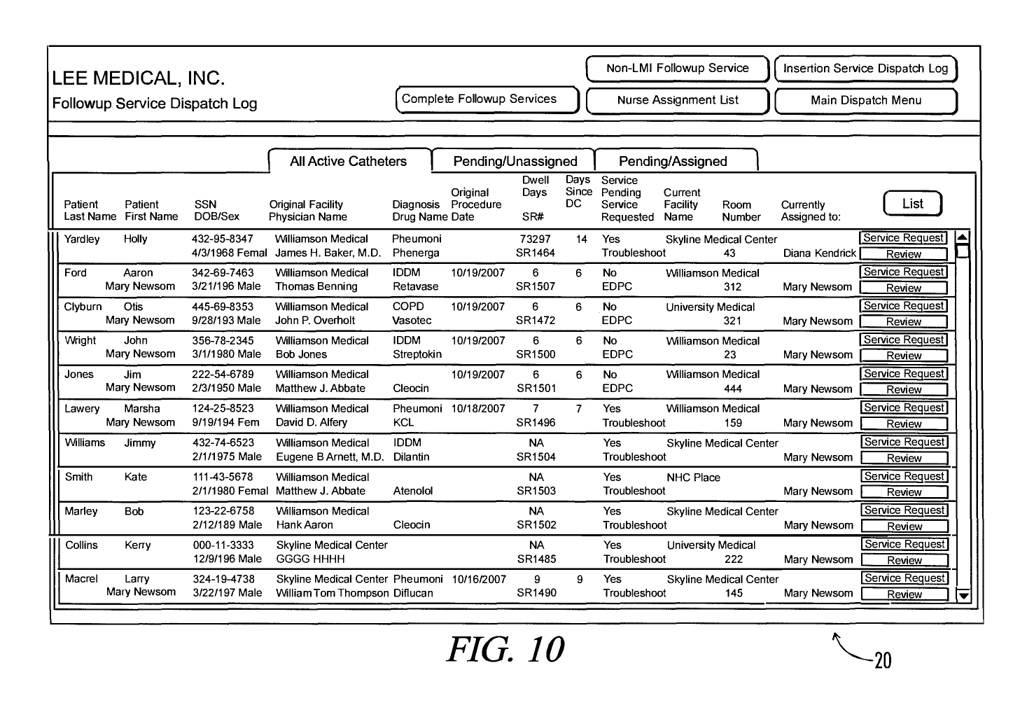

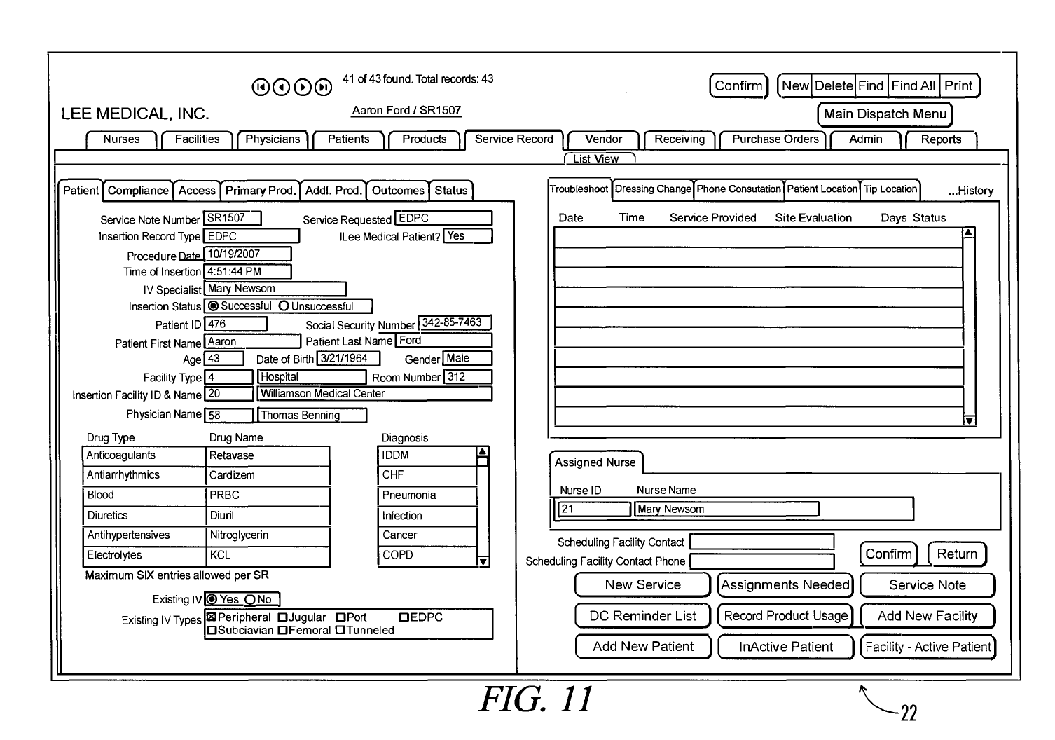

In another embodiment, shown in FIG. 8, the present invention is a system for tracking and maintaining vascular access records. The system includes a data storage device 78. Preferably, this is network server with a memory such as a hard drive. However, the data storage device 78 may embody a non-volatile memory, a magnetic tape, or an optical memory device. Furthermore, the data storage device 78 may actually be a group of several storage means. For example the data storage device 78 may be a collection of network servers.

The data storage device 78 is connected to a communication network 24. Desirably, the communication network 24 will utilize a LAN or WAN. However, an http-based infrastructure or mixed infrastructure is within the scope of the invention. The communication network 24 may connect the data storage device 78 to personal computers, network servers, printers (or other peripheral devices), and handheld devices. The communication network 24 may encompass wired connections such as CAT5 cables with RJ 45 connectors, USB, serial, parallel, or other conducting means or wireless connections such as those based on schemes like on 802.11a, b, g, CDMA, GSM, Bluetooth, UWB, infrared, or other comparable technologies.

A database 80 is stored in the data storage device 78. The database 80 is an organized grouping of some or all the information contained in the data storage device 78. Typical database implementations may utilize structured query language (SQL) or Microsoft Access to manipulate the information in data storage device 78. However the invention is not limited to a database 80 using only these implementations. The database 80 need not be contained solely on one device. As the data storage device 78 may be composed of multiple storage means, the database 80 too may be distributed throughout the different data storage means (all connected by the network 24).

The database 80 includes a patient record 84. In fact, the database 80 may contain many patient records 84, but, preferably, one and only one patient is affiliated with a particular patient record 84. A patient record 84 has at least the following components: a new vascular access service request field 82, a past service record 86 containing past vascular access service requests 30 from one or more providers, and a vascular access service entry 34 containing service data 88.

A vascular access service request field 82 provides a central location to store the new vascular access service requests 14 as they are received from a requesting healthcare entity 12. Thus, as a service request 14 is received for a given patient, the request 14 is associated with the vascular access service request field 82 and stored in the appropriate patient record 84. Desirably, the vascular access service field 82 is amended to include the new service request 14 through a network client 18 connected to the communication network 24.

Although only one network client 18 is described, the invention is not so limited. Rather, the present invention envisions multiple devices serving as network clients 18 depending, for example, on the volume of service requests or strictures demanded by the entity employing the system—like service request response time.

As a service request 14 is completed, the request 14 may be recorded as a past vascular access service request 30 and stored in the past service record 86. Alternatively, the service request 14 may simply be denoted as executed (thereby associating it with the past service record 86). Either way, the past service record 86 contains, or is at least affiliated with, all completed service requests from all requesters for a particular patient. This permits practitioners 26 to conveniently search the past service record 86 and readily identify whether a patient has been previously treated.

Also included in the patient record 84 is a vascular access service entry 34. The service entry 34 is typically generated after the new service request 14 has been completed and may contain service data 88 detailing patient treatment information such treatment course, patient's response to the treatment course, supplies used, pharmaceutics administered, or any other pertinent information. Most often the service entry 34 will be generated by the practitioner 26 handling the new service request 14. Preferably, the practitioner 26 will use a remote network device 52, connected to the communication network 24, to access, generate, and/or modify the service entry 34 or the patient record 8. The remote network device 52 may be a wireless PDA, a desktop computer, a laptop computer, or some other equivalent device.

Allowing practitioners 26 to access a patient record 84 after a new service request 14 has been assigned to them permits the practitioner 26 to look through the patient's vascular access history and determine if the patient has been treated in the past and what techniques or procedures proved fruitful. It also provides the practitioner 26 a conduit through which knowledge can be gained, from past service requests 30, as to how the patient might react to a yet unemployed vascular access procedure(s). Irrespective of how information from the patient record 84 is utilized, the knowledge acquired engenders practitioners 26 with the ability to avoid unnecessary procedures and minimize cost and discomfort for the patient.

The database 80 may also contain care and maintenance reports 90. These reports 90 have follow-up care instructions, practitioner notes, and/or other medical considerations. Preferably, the care and maintenance reports 90 may be created, amended, or viewed by the practitioner using the remote network device 52. This would allow the practitioner 26 to input all necessary information in the reports 90, subsequent the completion of the service request 14, even if the practitioner 26 is far removed from his/her base of operation.

In order to manage costs associated with new service requests 14, a charge document 92 may be stored in the database 80. The charge document 92 may be accessed through the network client 18 or the remote network device 52 so that cost information can be quickly and easily captured in the database 80. Furthermore, having a primary repository for cost information allows any purchase order requests, invoices, and other accounting-related documents or reports to be quickly and conveniently generated.

The present invention also envisions having a service receipt confirmation 94 stored in the database 80. Each new service request 14 would have a corresponding service receipt confirmation 94. The confirmation 94 provides a conduit through which a practitioner 26 may acknowledge the receipt of a new service request 14. This adds a layer of robustness to the system and ensures the new service request 14 will not be neglected. Additionally, if the practitioner 26 is not able to accept the new service request 14, the request 14 may be assigned to another practitioner. Preferably, the practitioner 26 will receive notice of the new service request 14 through the remote network device 52 and use the device 52 to confirm its receipt. The confirmation process may be affected by accessing the confirmation 94 and modifying it to reflect receipt or simply contacting the entity delivering the request 14 and confirming the request's receipt.

Although the embodiments of the invention described above are primarily discussed in the context of one practitioner 26 and one dispatch nurse, or the equivalent, the invention envisions (in fact prefers) a multitude of practitioners, nurses, accounting, and administrative personnel accessing the system simultaneously and modifying the files accordingly. However, it is also within the scope of the invention to have a rules based system which may give varying levels of access to different personnel depending on the scope of that person's duties. For example, a person handling billing may have no need to access a patient's medical files and, accordingly, may be restricted from accessing such files. This may vary from read-only permission to no access. Preferably, this rules-based architecture may be implemented by the use of user names and/or passwords.

Thus it is seen that the method for maintaining vascular access medical records of the present invention readily achieves the inns and advantageous mentioned as well as those inherent therein. Although certain preferred embodiments of the invention have been illustrated and described for purposes of the present disclosure, numerous changes may be made by those skilled in the art which changes are encompassed within the scope and spirit of the present invention and defined by the appended claims.

What is claimed is:

1. A system for tracking and maintaining vascular access medical records across a continuum of healthcare facilities, comprising:
means for centrally aggregating vascular access records in association with a patient, said vascular access records comprising past vascular access services rendered across one or more of a plurality of healthcare facilities having respectively compartmentalized vascular access records;
means for providing access by a third party vascular access service provider to the vascular access records, responsive to a new vascular access service request for the patient from any one of the plurality of the healthcare facilities; and
means for supplementing the vascular access records to reflect results from the new vascular access service request, wherein the results are available for access in association with subsequent vascular access service requests for the patient by any one of the plurality of healthcare facilities.

2. The system of claim 1, wherein supplementing the vascular access records to reflect results from the new vascular access service request comprises adding a vascular access service entry.

3. The system of claim 1, wherein supplementing the vascular access records to reflect results from the new vascular access service request comprises amending an existing vascular access service entry.

4. The system of claim 1, wherein supplementing the vascular access records to reflect results from the new vascular access service request comprises updating the vascular access records to include a new service request outcome.

5. The system of claim 1, wherein supplementing the vascular access records to reflect results from the new vascular access service request comprises updating the vascular access records and including a service request history.

6. The system of claim 1, wherein the results from the new vascular access service request are provided from the third party practitioner and independent of the requesting healthcare facility.

7. The system of claim 1, further comprising:
means for supplementing the vascular access records to reflect post-service results associated with the new vascular access service request, wherein the post-service results are available for access in association with subsequent vascular access service requests for the patient by any one of the plurality of healthcare facilities.

8. The system of claim 7, wherein supplementing the vascular access records to reflect post-service results associated with the new vascular access service request comprises adding a vascular access service entry.

9. The system of claim 7, wherein supplementing the vascular access records to reflect post-service results associated with the new vascular access service request comprises amending an existing vascular access service entry.

10. The system of claim 7, wherein the post-service results associated with the new vascular access service request are provided from the third party practitioner and independent of the requesting healthcare facility.

11. The system of claim 7, further comprising:
means for providing a purchase order to the one of the plurality of healthcare facilities as having requested the new vascular access service request, after completion of vascular access services associated with the new vascular access service request.

12. The system of claim 11, further comprising:
means for providing summary information to the healthcare facility regarding completion of the requested vascular access service request by the third party practitioner.

13. The system of claim 7, further comprising:
means for providing care and maintenance reports to the third party vascular access service provider regarding subsequent services for the patient associated with the new vascular access service request.

14. The system of claim 13, wherein the care and maintenance reports further comprise information regarding subsequent services for one or more additional patients associated with the healthcare facility making the new vascular access service request.

15. The system of claim 1, wherein the vascular access records associated with the patient comprise an IV status and IV type provided by a vascular access practitioner, and an associated vascular access site evaluation for each respective vascular access service request.

16. A system for tracking and maintaining vascular access medical records across a continuum of healthcare facilitators having previously requested vascular access services for a patient, comprising:
means for centrally aggregating vascular access records in association with a patient, said vascular access records comprising an amalgamation of past vascular access services rendered across a plurality of healthcare facilitators having respectively compartmentalized vascular access records;
means for providing access by a third party vascular access service provider to the vascular access records, responsive to a new vascular access service request for the patient from any one of the plurality of the healthcare facilitators; and
means for supplementing the vascular access records to reflect results from the new vascular access service request, wherein the results are available for access in association with subsequent vascular access service requests for the patient by any one of the plurality of healthcare facilitators.

17. The system of claim 16, further comprising:
means for supplementing the vascular access records to reflect post-service results associated with the new vascular access service request, wherein the post-service results are available for access in association with subsequent vascular access service requests for the patient by any one of the plurality of healthcare facilitators.

18. The system of claim 17, further comprising:
means for providing summary information to the healthcare facility regarding completion of the requested vascular access service request by the third party practitioner.

19. The system of claim 18, further comprising:
means for providing care and maintenance reports to the third party vascular access service provider regarding subsequent services for the patient associated with the new vascular access service request, and for one or more additional patients associated with the healthcare facilitator making the new vascular access service request.

20. A system for tracking and maintaining vascular access medical records across a continuum of healthcare providers, comprising:
means for centrally aggregating vascular access records in association with a patient, said vascular access records comprising past vascular access services rendered across one or more of a plurality of healthcare providers having respectively compartmentalized vascular access records;
means for providing access by any one of the plurality of the healthcare providers to the vascular access records, responsive to a new vascular access service request for the patient from said healthcare provider; and
means for supplementing the vascular access records to reflect results from the new vascular access service request, wherein the results are available for access in association with subsequent vascular access service requests for the patient by any other one of the plurality of healthcare providers.
